(19) United States
(12) Patent Application Publication
(10) Pub. No.: US 2007/0031219 A1
(43) Pub. Date: Feb. 8, 2007

(54) Load receiving means for single or multiple deep storage and retrieval of objects into and from a shelf

(76) Inventor: Axel Besch, Wiesbaden (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/186,064

(22) Filed: Jul. 21, 2005

(51) Int. Cl. B65G 65/00

(52) U.S. Cl. 414/277

(57) ABSTRACT

A load take-up means for the storage and retrieval of objects in and from a rack has a base frame and at least three telescopic sections which can be extended and retracted by way of traction means. One traction means is guided toward deflection wheels mounted at the ends of the base frame and is deflected toward deflection wheels arranged oppositely at the ends of the first telescopic section, from where it is guided in the opposite direction toward attachment points provided on the second telescopic section and is fastened there. Some ends of the traction means of a further pair of traction means are attached to the first telescopic section, and are guided there toward deflection rollers provided at opposite ends of the second telescopic section and further, in the opposite direction, toward attachment points at the ends of the third telescopic section and are attached there.

### FIELD OF THE INVENTION

The present invention relates to a load take-up means for the single- and multiple-deep storage and retrieval of objects in and from a rack with at least double-deep storage capacity.

### BACKGROUND OF THE INVENTION

In the case of double-deep or multiple-deep storage of objects, generally unit loads, in racks, it is known to use storage and retrieval units with load take-up means which, by way of telescopically extendable forks, engage in the racks and take up or set down the unit load. The unit loads are usually positioned with the aid of suitable bearing elements at such a height that a load take-up means is able to engage below them. Hat profiles made of steel which produce the spacing between the unit load and the support and create the necessary space for the passage of the telescopic load take-up means are known. However, such known hat profiles are typically disadvantageous because on the one hand they occupy valuable storage space which cannot otherwise be used, and on the other hand, being structural steel elements, they are heavy and expensive.

In order to save on these structural steel elements, use has been made of telescopic load take-up means, such as three telescopic sections of which can be displaced independently of one another and thus occupy relatively little space during storage and retrieval. Telescopic load take-up means, advantageously in conjunction with so-called “offset bars”, are therefore sometimes employed in rack construction, which leads to cost savings due to the omission of hat profiles.

Known load take-up means with three independently extendable telescopic arms are ordinarily equipped with two drives, such as is described in German Pat. No. DE 195 49 288 C1, which is hereby incorporated herein by reference. The load take-up means shown therein features a base frame with a telescopic arm arranged thereon which has three extendable telescopic sections. The extension drive comprises two loop drives which are arranged on the base frame. It is possible by variously actuating the drives to extend and retract the individual telescopic sections by way of drive chains. Control takes place via a position-measuring system, such as, for example, by determining the number of rotations of the motor shafts of the loop drives. Both drives must be controlled or braked in exact coordination with one another.

### SUMMARY OF THE PRESENT INVENTION

An object on which the present invention is based is to simplify the known load take-up means and thus to produce it in a cost-effective manner.

It is proposed according to the invention that a locking unit for temporarily locking the first telescopic section with respect to the base frame is provided between the base frame and the first telescopic section. This locking unit makes it possible to dispense with one of the drives without adversely affecting the functionality of the device and the independent nature of the extension and retraction movements of the telescopic sections. With the drive being dispensed with, there is also no need for the traction means used in the prior art to produce the connection between the second drive and the first telescopic section.

Skillful chain or cable guidance and combining of the locking of the base frame and the first telescopic section with the inventive fastening or securing of the deflection wheels arranged at the ends of the first telescopic section and/or of the first traction means makes it possible, as a result of the traction means and telescopic sections being skillfully blocked alternately, to bring about or prevent an extension of individual telescopic sections.

If, according to a further feature of the invention, provision is made for the first and second telescopic sections to be lockable relative to one another in the extended state of the second and third telescopic sections, then it is possible by unlocking the first telescopic section from the base frame and reversing the direction of rotation of the drive motor to further extend the first telescopic section together with the already extended second and third telescopic sections.

Of course, the invention can also be applied in the case of load take-up means which have more than three telescopic sections, with the traction means being guided in an equivalent manner.

A method for the single- and multiple-deep storage of objects in a rack with at least double-deep storage capacity by means of a device such as described above is defined by the base frame and the first telescopic section being locked to one another. The traction means is drawn via a loop drive corresponding to the direction of rotation of the drive and moves the second telescopic section in the direction of storage as a result of the cable guidance and fastening of the cable ends. The third telescopic section with the load to be stored is extended simultaneously by the further traction means. After the second and the third telescopic section have reached their end positions, the base frame and the first telescopic section are unlocked from one another and the first traction means is fastened to the first telescopic section. The first telescopic section is extended in the direction of storage together with the already extended second and third telescopic sections.

The device and the method according to the present invention result in substantial advantages over the prior art. For example, dispensing with one drive and its associated traction means while ensuring that the individual telescopic sections have independent mobility makes it possible to achieve reductions in the weight of the telescopic arm. Also, the mechanical components of the locking or fastening means can be substantially or many times lighter than a second drive. The savings in weight may be accompanied by savings in production costs. Furthermore, the capacity of the load take-up means and of the storage and retrieval unit are increased since the reduced mass of the telescopic arm permits either a higher useful load and/or makes higher accelerations and speeds possible. The vibration behavior of the storage and retrieval unit is positively influenced such that it is possible, even with critical tolerances, for the telescopic sections to be retracted simply.

### BRIEF DESCRIPTION OF THE DRAWINGS

An exemplary embodiment of the invention is described and explained hereinbelow by means of a basic representation, in which:

FIG. 1 shows the load take-up means of the present invention in the retracted state;

FIG. 2 shows the load take-up means of FIG. 1 in the partially extended state; and

FIG. 3 shows the load take-up means of FIGS. 1 and 2 in the fully extended state.

### DESCRIPTION OF THE PREFERRED EMBODIMENTS

The reference numeral 1 is used in the highly schematic representation to denote the base frame of the load take-up means, on which are arranged the telescopic sections 2, 3 and 4, such that they can preferably be extended to both sides. The reference numeral 5 denotes the drive mechanism or motor or means, which in the illustrated embodiment comprises a loop drive with a chain wheel, around which partially loops the traction means, in this case a drive chain or cable 6. The drive chain 6 is guided over the deflection chain wheels 9a arranged generally at or near both sides or opposite ends of the base frame 1, is diverted there in the opposite direction, and is routed crosswise toward the deflection chain wheels 9b arranged generally at or near both or opposite ends of the first telescopic section 2, where it is again deflected and guided crosswise toward attachment points generally at or near both or opposite ends of the second telescopic section 3, where the chain or chains is/are attached to the second telescopic section.

A locking element or means 7 is provided between the base frame 1 and the first telescopic section 2. The locking means temporarily blocks the ability of the first telescopic section 2 to extend with respect to the base frame 1. The locking means 7 can be designed mechanically or with pressure medium operation in any suitable or known manner. For example, a pin or other locking element may be inserted into a corresponding aperture in the opposite part and fastened there.

A “flyer chain”, such as formed by a pair of traction means 10a and 10b, is attached at both ends to each of the end regions of the telescopic section 2, such as at the upper side of the first telescopic section 2. The flyer chain or cable is guided crosswise over the deflection wheels 9c, which are located generally at or near opposite ends of the second telescopic section 3, and toward attachment points 11 at or near both or opposite ends of the last (third) telescopic section 4.

A second fastening means 8 is provided on the first telescopic section 2. The second fastening means 8 can be used either to block the deflection wheels 9b on the first telescopic section 2 or the chain 6 on the first telescopic section. The fastening means 8 is able to be released and locked by remote control. The fastening means or locking device thus functions to selectively limit or substantially preclude rotation of the deflection wheels 9b and/or movement of the chain 6 at or about the deflection wheels 9b.

The operation of the load take-up means of the present invention is described in the text below:

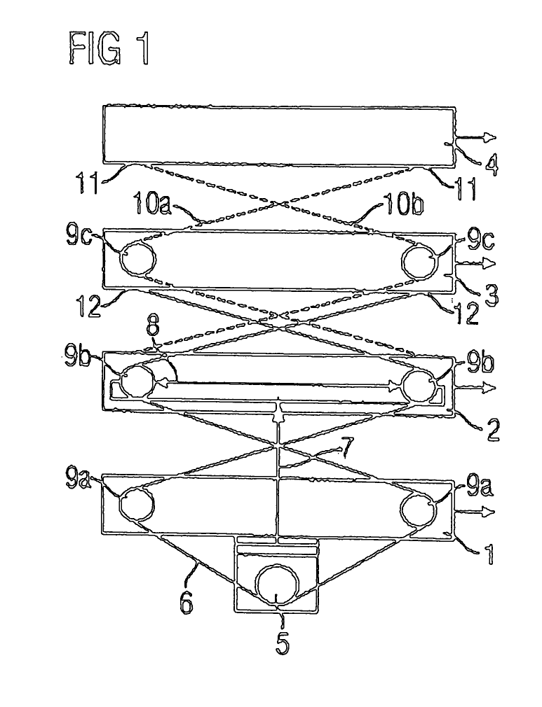

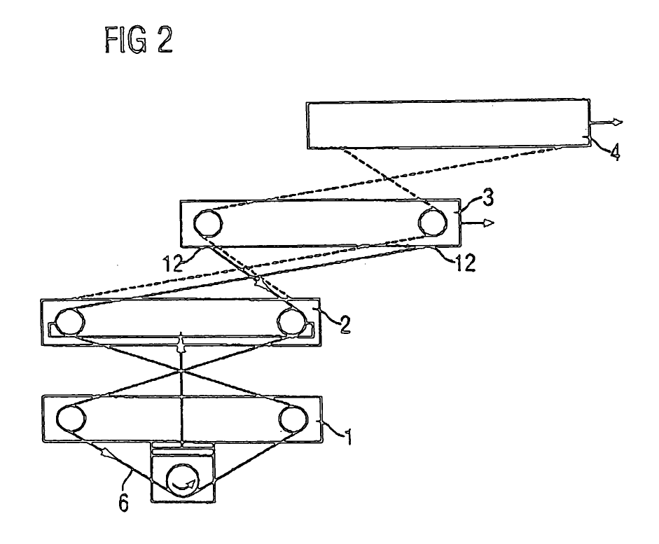

From the starting position represented in FIG. 1, the load take-up means is to be initially moved into the position represented in FIG. 2. The telescopic sections 3 and 4 are thus to be extended independently of the telescopic section 2. The drive 5 is actuated in the direction of the arrow (shown in FIG. 2) and, by way of the drive chain 6, which is attached to the second telescopic section 3 at attachment points 12, draws the telescopic section 3 to the right (in the drawing). By means of the further pair of traction means, i.e. the flyer chain or chains 10a, 10b, which has its attachment points on the telescopic sections 2 and 4 (such as at attachment points 11), the telescopic section 4 as well is extended simultaneously with the telescopic section 3 in the represented deflection and guidance of the flyer chain over the deflection wheels 9c. An extension of the first telescopic section 2 is undesirable and is prevented by the locking means 7, which prevents the relative movement between the base frame 1 and the first telescopic section 2.

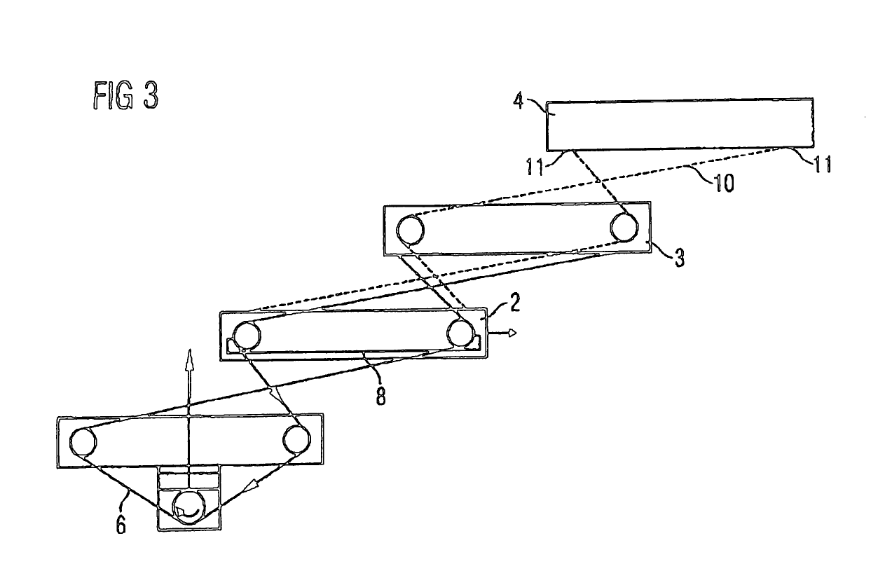

If the load take-up means is to be fully extended for double-deep storage and retrieval, what happens then is that, after the telescopic sections 3 and 4 have reached their end position, the connection between the base frame 1 and the first telescopic section 2 is broken by unlocking the locking means 7. At the same time, the drive chain 6 or its chain wheels are fastened by way of the fastening means 8 in the region of the first telescopic section 2 in such a way that two fixed points for the drive chain 6 are thereby provided virtually transiently on the first telescopic section 2. When the direction of rotation of the drive 5 is reversed, these “fixed points” then also bring about an extension of the first telescopic section 2, together with the already extended second and third telescopic sections 3 and 4 arranged thereon, in the direction of the arrow (shown in FIGS. 1-3) until a position is reached in which all three telescopic sections 2, 3 and 4 are fully extended (such as shown in FIG. 3).

Optionally, and according to another aspect of the present invention, the fixing or fastening means 8 may be replaced by temporarily producing a fixed connection between the first telescopic section 2 and the second telescopic section 3 and thereby providing the fastening or securing or locking.

Changes and modifications to the specifically described embodiments may be carried out without departing from the principles of the present invention, which is intended to be limited only by the scope of the appended claims, as interpreted according to the principles of patent law.

1. A load take-up means for single- and multiple-deep storage and retrieval of objects in and from a rack with at least double-deep storage capacity, said load take-up means comprising:
a base frame provided on a lifting device;
a telescopic arm arranged on said base frame;
at least three motor-driven telescopic sections comprising first, second and third telescopic sections, said telescopic sections being configured to extend and retract by way of first and second traction means, said first traction means being guided from a drive motor toward first deflection wheels mounted generally at opposite ends of said base frame, said first traction means being deflected toward second deflection wheels arranged generally at opposite ends of said first telescopic section, from where said first traction means is guided in the opposite direction toward attachment points provided generally at opposite ends of said second telescopic section and is fastened there, said second traction means being attached generally at said opposite ends of said first telescopic section and being guided from said opposite ends of said first telescopic section and, crossing one another, toward third deflection rollers provided generally at opposite ends of said second telescopic section, and further guided in the opposite direction toward attachment points generally at opposite ends of said third telescopic section, said second traction means being attached at said opposite ends of said third telescopic section; and
a locking unit for temporarily locking said first telescopic section with respect to said base frame, said locking unit being provided between said base frame and said first telescopic section.

2. The load take-up means for the single- and multiple-deep storage and retrieval of objects as claimed in claim 1, wherein said first traction means comprises at least one cable or chain.

3. The load take-up means for the single- and multiple-deep storage and retrieval of objects as claimed in claim 1, wherein said second traction means comprises at least one cable or chain.

4. The load take-up means for the single- and multiple-deep storage and retrieval of objects as claimed in claim 1, wherein said first deflection wheels are arranged at the ends of said first telescopic section and said first traction means are securable relative to said first telescopic section in the region of the ends of said first telescopic section.

5. The load take-up means for the single- and multiple-deep storage and retrieval of objects as claimed in claim 4, wherein said first and second telescopic sections are lockable relative to one another in the extended state of said second and third telescopic sections.

6. The load take-up means for the single- and multiple-deep storage and retrieval of objects as claimed in claim 5, wherein said telescopic arm comprises more than three telescopic sections.

7. The load take-up means for the single- and multiple-deep storage and retrieval of objects as claimed in claim 4, wherein said telescopic arm comprises more than three telescopic sections.

8. The load take-up means for the single- and multiple-deep storage and retrieval of objects as claimed in claim 1, wherein said first and second telescopic sections are lockable relative to one another in the extended state of said second and third telescopic sections.

9. The load take-up means for the single- and multiple-deep storage and retrieval of objects as claimed in claim 1, wherein said telescopic arm comprises more than three telescopic sections.

10. A method for the single- and multiple-deep storage of objects in a rack with at least double-deep storage capacity, said method comprising:
a. providing a load take-up means for single- and multiple-deep storage and retrieval of objects in and from a rack with at least double-deep storage capacity, said load take-up means comprising:
a base frame provided on a lifting device;
a telescopic arm arranged on said base frame;
at least three motor-driven telescopic sections comprising first, second and third telescopic sections, said telescopic sections being configured to extend and retract by way of first and second traction means, said first traction means being guided from a drive mechanism toward first deflection wheels mounted generally at opposite ends of said base frame, said first traction means being deflected toward second deflection wheels arranged generally at opposite ends of said first telescopic section, from where said first traction means is guided in the opposite direction toward attachment points provided generally at opposite ends of said second telescopic section and is fastened there, said second traction means being attached generally at said opposite ends of said first telescopic section and being guided from said opposite ends of said first telescopic section and, crossing one another, toward third deflection rollers provided generally at opposite ends of said second telescopic section, and further guided in the opposite direction toward attachment points generally at opposite ends of said third telescopic section, said second traction means being attached at said opposite ends of said third telescopic section;
b. locking said base frame and said first telescopic section to one another;
c. drawing said first traction means via said drive mechanism corresponding to the direction of rotation of the drive and moving said second telescopic section in the direction of storage as a result of said first and second traction means;
d. extending said third telescopic section with the load to be stored simultaneously by said second traction means;
e. after the second and the third telescopic section have reached their end positions, unlocking said base frame and said first telescopic section from one another and securing said first traction means relative to said first telescopic section; and
f. extending said first telescopic section in the direction of storage together with the already extended second and third telescopic sections.

11. The method of claim 10, wherein said first traction means comprises at least one cable or chain and said second traction means comprises at least one cable or chain, said second and third telescopic sections being movable in the direction of storage as a result of cable or chain guidance and fastening of the cable or chain ends at said second and first telescopic sections.

12. The method of claim 10, wherein said first deflection wheels are arranged at the ends of said first telescopic section and said first traction means are securable relative to said first telescopic section in the region of the ends of said first telescopic section.

13. The method of claim 12, wherein said first and second telescopic sections are lockable relative to one another in the extended state of said second and third telescopic sections.

14. The method of claim 10, wherein said first and second telescopic sections are lockable relative to one another in the extended state of said second and third telescopic sections.

15. The method of claim 10, wherein extending said first telescopic section in the direction of storage comprises driving said drive mechanism in an opposite direction of rotation.

16. The method of claim 10, wherein said telescopic arm comprises more than three telescopic sections.
